(19) United States
(12) Patent Application Publication
(10) Pub. No.: US 2006/0084005 A1
(43) Pub. Date: Apr. 20, 2006

(54) Means to enable slitting of micro-encapsulated media

(75) Inventors: Alphonse D. Camp, Rochester, NY (US); Thomas D. Russell, Webster, NY (US)

Correspondence Address: Mark G. Bocchetti;Paten Legal Staff, Eastman Kodak Company, 343 State Street, Rochester, NY, 14650-2201, US

(73) Assignee: Eastman Kodak Company

(21) Appl. No.: 10/968,581

(22) Filed: Oct. 19, 2004

(51) Int. Cl. G03C 1/72

(52) U.S. Cl. 430/138

(57) ABSTRACT

A continuous finishing operation that utilizes a method of slitting microencapsulation imaging media entails irradiating microencapsulated imaging media with a light sensitive side forming a first polymerization pattern. The light sensitive side comprises an emulsion with capsules containing leuco forming dyes suspended in a matrix containing developer. A frequency of visible energy is applied to the capsules to polymerize the capsules into the first polymerization pattern. The media is then slit among the first polymerization pattern. The media is irradiated a second time forming a second pattern and is slit forming a borderless print of a desired size.

### CROSS REFERENCE TO RELATED APPLICATIONS

### Field of the Invention

The present embodiments relate to methods for providing a continuous process to enable slitting of micro-encapsulated media.

### BACKGROUND OF THE INVENTION

The problem to be solved by the present embodiments is to provide borderless prints without a “bleed edge.” A “bleed edge” is typically caused by pigment capsule rupture during slitting by pre-exposing a narrow line prior to sheet conversion (See U.S. Pat. No. 5,974,992). The present embodiments were designed to meet these needs in a kiosk or smaller setting.

### SUMMARY OF THE INVENTION

The method is for use in a continuous finishing operation. The method involves slitting microencapsulation imaging media, irradiating microencapsulated imaging media with a light sensitive side that comprises an emulsion with capsules containing leuco forming dyes suspended in a matrix containing developer. Next, a first frequency of visible energy is beamed at the light sensitive side to polymerize a first set of the capsules containing leuco forming dyes into a first polymerization pattern and then slitting the microencapsulated imaging media into smaller microencapsulated imaging media. Finally, the slit web media is then irradiated with a second beam of visible energy to polymerize a second group of capsules into a second pattern and then chopped to match the second pattern.

The present embodiments solves the problems associated with trying to create borderless prints without a “bleed edge.” The “bleed edge” is typically caused by capsule rupture during slitting by pre-exposing a narrow line prior to sheet conversion (slitting and chopping) using LEDs.

### BRIEF DESCRIPTION OF THE DRAWINGS

In the detailed description of the preferred embodiments presented below, reference is made to the accompanying drawings, in which:

FIG. 1 depicts a cross-sectional view of a slitting apparatus used in an embodiment of the method of slitting microencapsulation imaging media.

FIG. 2 depicts a detailed view of the knives usable in the method.

FIG. 3 depicts a top view of the slitting step in an embodiment of the method utilizing an LED.

FIG. 4 depicts a top view of the chopping step in an embodiment of the method utilizing the LED and guillotine knives.

FIG. 5 depicts a side view of the chopping step in an embodiment of the method illustrating an orientation of the LEDs with respect to the knives.

FIG. 6 depicts a cross-sectional view of the emulsion of the light sensitive side usable in an embodiment of the method.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The present embodiments provide a method for a continuous finishing process for slitting microencapsulated web media. The methods were designed to provide borderless color prints, which are highly desirable to consumers.

The present methods provide a manner of polymerizing capsules containing dye on an emulsion side of microencapsulated media. The media is then cut to provide a borderless print with less effort and at a lower cost than current methods to produce prints.

Microencapsulation media is typically media with a light sensitive side and a non-light sensitive back. Examples of microencapsulation media include synthetic paper commonly available on the market, polyolefins—such as a thin film polypropylene—, and cellulose paper bases. For example, a polyproplyene synthetic paper having polyolefin resin coated layers oriented on both sides, such as an 8-mil Granwell Polylith GC2 paper, can be used. These types of media are typically corona discharge treated before use in this process. The light sensitive side in the microencapsulation media typically has an emulsion with capsules containing leuco forming dyes suspended in a matrix containing developer.

Typically, the light sensitive side is made of three layers. The first layer contains (1) cyan leuco forming dyes in monomer capsules, (2) yellow leuco forming dyes in monomer capsules, (3) magenta leuco forming dye, (4) black leuco forming dye in monomer capsules, (5) a styrenic zinc salicylate developer, and (6) a binder.

The monomer capsules typically include a photo initiator coating on the outside of the capsule. The capsules shells can be a monomer of tri-methylo-L-propane tri-acrylate. Typically, equal amounts of the cyan, magenta, and yellow capsules are used in the first layer of the emulsion. The binder can be any commercially available binder, such as Airflex 465™. Published U.S. patent application US 2002/0045121 provides an additional teaching on the light sensitive emulsion and is hereby incorporated into this application by reference.

The second layer on the light sensitive side is located over the first layer and typically contains an ultraviolet protection (UV) layer, which can be a gelatin with a UV inhibiting agent. A third layer is disposed atop of the second layer and comprises a gelatin and lubricants, such as polydimethylsiloxane and Ludox AM™. The third layer is unexpectedly an abrasion resistant layer.

The microencapsulation media can be a web material that is formed into rolls or, alternatively, single sheets. If the web media is a roll media, the roll media can be between 30 inches wide and 180 inches wide and between 9 linear feet and 18,000 linear feet long. A preferred roll size of the microencapsulation media is 42 inches wide and 11,000 linear feet long. An alternative usable size for the microencapsulation media roll is 52 inches wide and 9000 linear feet long.

An embodiment of this method of slitting microencapsulation imaging media begins by irradiating a roll of microencapsulated imaging media with a light sensitive side using a first frequency of visible energy and forming a polymerization pattern. By irradiating the light side of the roll, the capsules on the microencapsulation media are polymerized into a pattern that matches the point of contact with the beam. The visible energy, or light, is preferably projected in a tight beam. The impact area of the beam is preferably less than 2 millimeters in diameter. The beam should have a point spread function that results in a line that is not wider than two millimeters. In other words, the imaged line formed by the beam is less that two millimeters, but the beam spread can be less than two millimeters in order to accommodate the desired imaged line width. Typically, the irradiation step requires between 1 millisecond and 100 milliseconds to complete.

The visible energy forming the light beam is typically from a red visible light source, a green visible light source, and/or a blue visible light source. An individual light source or a combination of these light sources can be used. The light can be generated from a light emitting diode (LED) or from a laser, such as a helium neon laser, a red laser, a gas laser, or solid state laser, or other colored lasers. The use of the LED as the light source is an inexpensive solution to yield a polymerization pattern. A strong incandescent lamp or a metal halide lamp can be used as a visible energy source. A bifurcated fiber optic bundle can be used with the metal halide lamp to facilitate the polymerization of the site specific areas of the media in tight beams while providing flexibility to orient the beam.

If a red visible light source is used, the preferred frequency is between 620 nanometers and 680 nanometers. If a green visible light source is used, the preferred frequency is between 500 nanometers and 550 nanometers. If a blue visible light source is used, the preferred frequency is between 420 nanometers and 460 nanometers.

The next step involves slitting the polymerized microencapsulated imaging media into smaller microencapsulated imaging media along the patterned line forming a slit web media. Slitting the microencapsulated media can be performed by any known slitting process, typically utilizing slitting equipment. An example of slitting equipment is described in co-owned U.S. Pat. No. 5,974,922 and is hereby incorporated into this application by reference.

After the slitting step, the slit web media is stopped for a period of time, ranging from 1 millisecond and 100 milliseconds depending upon the emulsion speed. The faster the emulsion speed, the shorter the stop time for the web media at this point.

After the slit web media is stopped, the slit web media is irradiated using a second frequency of visible energy to polymerize a second set of the capsules into a second polymerization pattern. Typically, the second frequency is the same as the first frequency used in the first polymerization step. The main difference in the irradiation steps is the orientation of the paper. The paper is orientated 180 degrees from the position where the first irradiation occurs. The irradiation step preferably takes between 1 millisecond and 100 milliseconds to complete.

The knives used to chop the slit web media are aligned with the second polymerization pattern. The knives cut the slit web media in the second pattern thereby forming a cut sheet that is the print sized borderless, photographic image. During the cutting, skating or wobbling can occur. The lights mounted in can be mounted on the knives to reduce the wobble. In the embodiment wherein the lights are attached to the knife, the versatility of the slitting machine is increased because the machine can form various sizes of encapsulated media, such as 5″×7″ images or 10″×18″ images.

The amount of power needed to complete both irradiation steps to polymerize the first and the second sets of the capsules is between about 8000 ergs/cm² and 10,000 ergs/cm², preferably 9000 ergs/cm². If the emulsion speed is faster, less power is needed; if the emulsion speed is slower, more power is needed. The rate that the emulsion is moving is the limiting factor in the power requirements of the embodied method.

The method can utilize one or more rotary anvils and one or more knives to perform the slitting. The knives are preferably positioned at a rake angle, typically ranging between about 50 degrees and 70 degrees. The microencapsulated media passes between the anvil and the knife in order to cut the microencapsulated media. The knives typically overlap the anvil by 0.015 inches to 0.060 inches. The knives are driven at a speed about two percent to five percent greater than the speed of the microencapsulated media.

In a preferred embodiment, the knives are positioned at a rake angle of about 60 degrees. At least one rotary knife is mounted on a first shaft and at least one anvil knife is mounted on a second shaft. The microencapsulated media is fed between the first and second shafts. The knife has a lateral force against the anvil of between 9 Newtons and 23 Newtons. The rotary knife has a positive relief angle between 1 degree and 6 degrees. The light sensitive side is positioned in cutting such that the knife contacts the emulsion side. Alternatively, the side opposite the light sensitive size can be positioned such that the knife contacts the side opposite the light sensitive size instead of the light sensitive side. The rake angle and the lateral force must be adequate to allow the media to be cut without tearing.

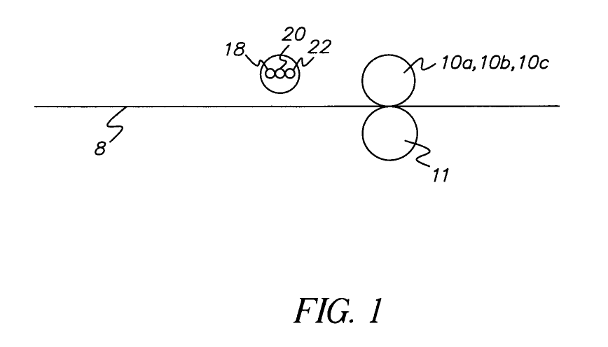

With reference to the figures, FIG. 1 depicts a cross-sectional view of a slitting apparatus usable in an embodiment of the method of slitting microencapsulation imaging media.

The encapsulated image web media 8 is passed through a sequence of rollers to a slitting apparatus. The slitting apparatus includes a male knife 10a, 10b, and 10c and a female knife 11. The female knife is alternative termed an anvil in this application. FIG. 1 depicts the embodiment using a red LED 18, a blue LED 20, and a green LED 22 directed at the image web media 8 for the first polymerization. The order of the LED lights is not critical.

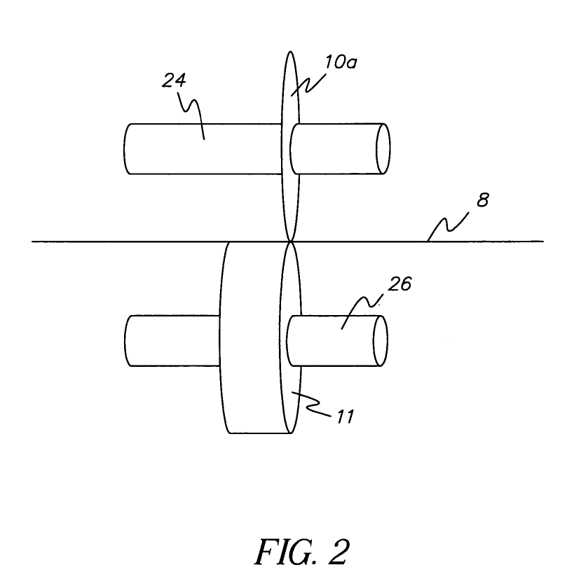

FIG. 2 depicts a detailed view of the knives usable in the method. The embodiment of the male knife 10a depicted in the figure has a shaft 24 perpendicular to the male knife 10a. The male knife 10a rides against the edge of the anvil 11 with a shaft 26. The combination of the male knife 10a with the anvil 11 cuts the media 8 in manner similar to shears.

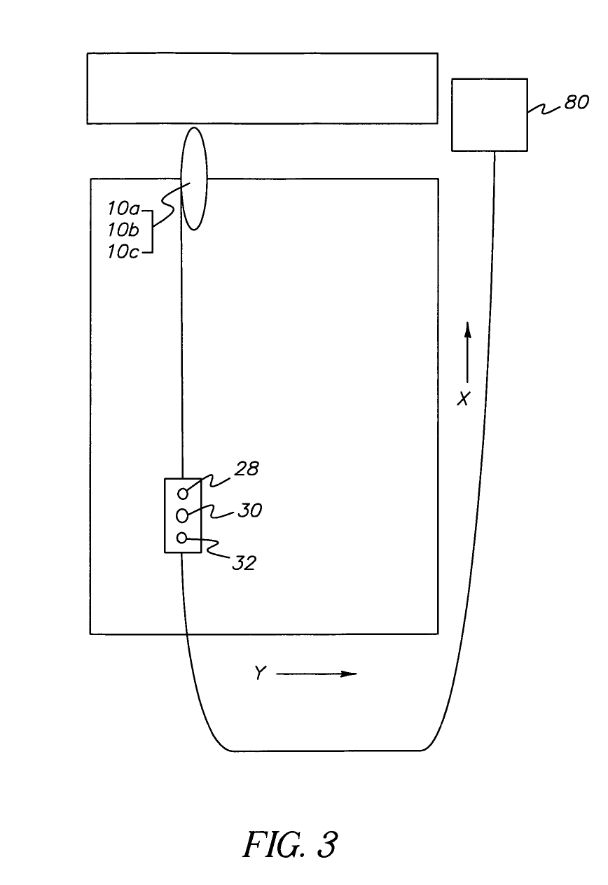

FIG. 3 depicts a top view of the slitting step in an embodiment of the method utilizing an LED. The figure depicts the first polymerization pattern 28, 30, and 32 that corresponds to the red LED 18, the blue LED 20, and the green LED 22 polymerization capsules on the light sensitive side. The LEDs form a white line used to irradiate the capsules in a defined pattern. The media 8 is then cut along the formed line or pattern using the knives 10a, 10b, and 10c. The web media 8 is shown oriented in an x-y orientation. In the most preferred embodiment, the LEDs are fixed in line relative to the knives. As the knives are adjusted, the LEDs follow the motion of the knives. A web velocity controller 80 connects to the LEDs. The web velocity controller 80 senses the velocity of the media 8 and modulates the intensity of the LEDs accordingly. The polymerization can be made along a curved line, a jagged line, or a straight line.

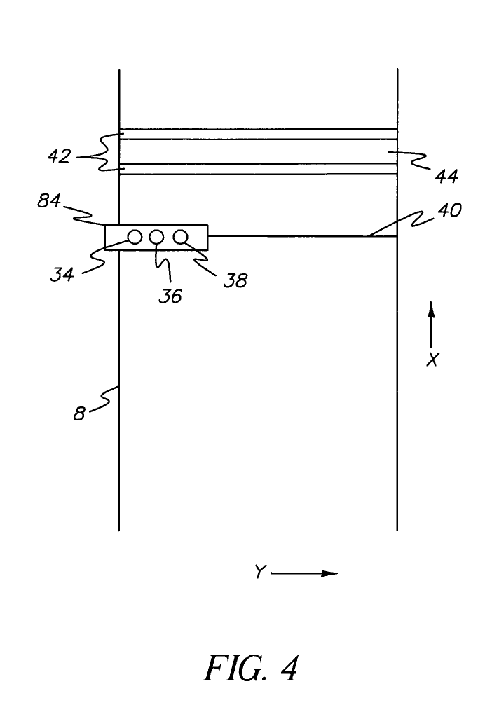

FIG. 4 depicts a top view of the chopping step in an embodiment of the method utilizing the same three LEDs and set of guillotine knives. The figure shows the second polymerization pattern 34, 36, and 38 that corresponds to the original red LED 18, the blue LED 20, and the green LED 22 forming a pattern similar to the first polymerization pattern 28, 30, and 32 shown in FIG. 3. The LEDs form a white line and are used to irradiate the capsules in an orientation different from the first irradiation step. The media 8 is then cut using the guillotine 42 using a backing 44 to receive the guillotine knives. In the embodiment depicted in FIG. 4, the LEDs preferably transverse across the “y” direction so that the LEDs are aligned with the guillotine 42 prior to the knife cutting the media 8. The LEDs can be mounted in a moveable module so that one set of the LEDs can be used to polymerize two lines that are orientated up to 180 degrees apart from one another. A controller 84 can be connected to the guillotine 42 to sense the position of the media 8 relative to the guillotine knives.

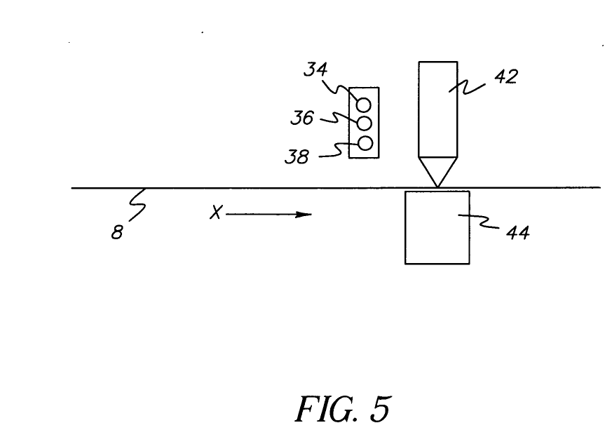

FIG. 5 depicts a side view of the chopping step wherein the media 8 passes in the “x” direction under the LEDs and transverses across the “y” direction of the media 8 and between the guillotine 42 and the backing 44. The figure shows the second polymerization pattern 34, 36, and 38.

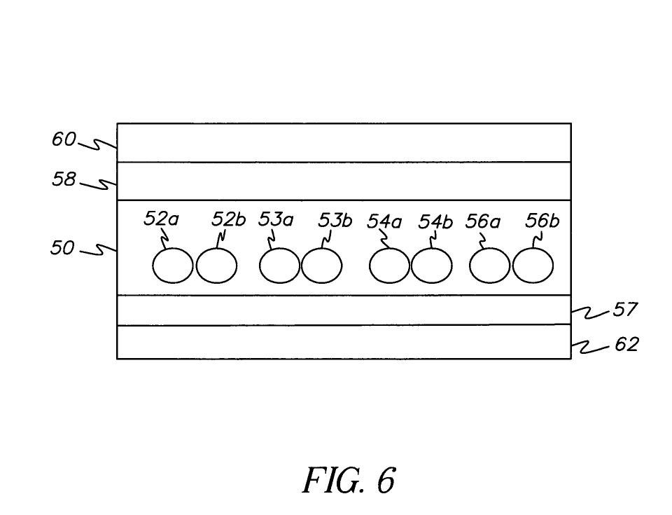

FIG. 6 depicts a cross-sectional view of the emulsion and the typical three layer construction for the media 8. The first layer 50 has yellow capsules 52a and 52b, black capsules 53a and 53b, magenta capsules 54a and 54b, and cyan capsules 56a and 56b. The capsules in the first layer 50 are all in an emulsion 57. The second layer 58 is disposed over the first layer 50 and further contains UV stabilizers. The third layer 60 is disposed over the second layer 58. All three layers are disposed on a substrate 62, such as a polypropylene substrate. The combined layers can include additional abrasion resistant substances that enable polishing of the top layer.

The invention has been described in detail with particular reference to certain preferred embodiments thereof, but it will be understood that variations and modifications can be effected within the spirit and scope of the invention.

### PARTS LIST

8. encapsulated image web media

10a. knife

10b. knife

10c. knife

11. female knife or anvil

18. red led

20. blue led

22. green led

24. shaft

26. shaft

28. first polymerization pattern

30. first polymerization pattern

32. first polymerization pattern

34. second polymerization pattern

36. second polymerization pattern

38. second polymerization pattern

40. white line

42. guillotine

44. backing

50. layer

52a. yellow capsules

52b. yellow capsules

53b. black capsules

53b. black capsules

54a. magenta capsules

54b. magenta capsules

56a. cyan capsules

56b. cyan capsules

57. emulsion

58. second layer

60. third layer

62. polypropylene substrate

80. web velocity controller

84. controller

1. A method of slitting and chopping microencapsulation imaging media for photographic images to provide borderless color prints without a bleed edge, wherein the method comprises the steps of:
a. irradiating microencapsulated imaging media including a light sensitive side having an emulsion with capsules containing leuco forming dyes suspended in a matrix containing developer;
b. using a first frequency of visible energy to polymerize a first set of the capsules into a first polymerization pattern;
c. slitting precisely the microencapsulated imaging media into a plurality of smaller microencapsulated imaging media along the first polymerization pattern to form a slit web media;
d. stopping the slit web media;
e. irradiating the stopped slit web media using a second frequency of visible energy to polymerize a second set of the capsules into a second polymerization pattern that is oriented differently than the first polymerization pattern; and
f. chopping the slit web media along the second polymerization pattern to form a cut sheet of borderless color prints without a bleed edge.

2. (canceled)

3. The method of claim 1, wherein the visible energy is selected from the group consisting of a red visible light source, a green visible light source, a blue visible light source, and combinations thereof.

4. The method of claim 3, wherein the red visible light source comprises a frequency ranging between 620 nanometers and 680 nanometers.

5. The method of claim 3, wherein the green visible light source comprises a frequency ranging between 500 nanometers and 550 nanometers.

6. The method of claim 3, wherein the blue visible light source comprises a frequency ranging between 420 nanometers and 460 nanometers.

7. The method of claim 1, wherein the microencapsulated imaging media is a roll, wherein the roll comprises a width between 30 inches and 180 inches and a length between 9 linear feet and 18,000 linear feet.

8. The method of claim 1, wherein the steps of irradiating the microencapsulated imaging media and irradiating the slit web media are each performed for a time period between 1 millisecond and 100 milliseconds.

9. The method of claim 1, wherein the steps of using the first and second frequencies of visible energy to polymerize the first and second sets of the capsules into the first and second polymerization patterns utilizes power betweens 8000 ergs/cm² and 10,000 ergs/cm².

10. The method of claim 1, wherein the step of irradiating the stopped slit web media using a second frequency of visible energy to polymerize a second set of the capsules into a second polymerization pattern that is oriented differently than the first polymerization pattern is one in which the second polymerization pattern is oriented 180 degrees from the first polymerization pattern.

11. The method of claim 1, wherein the step of slitting the microencapsulated imaging media comprises the steps of:
a. providing a rotary anvil and a rotary knife, wherein the rotary knife comprises a rake angle between about 50 degrees and about 70 degrees;
b. passing microencapsulated imaging media between the rotary anvil and the rotary knife to cut the microencapsulated imaging media, and wherein the rotary knife overlaps the rotary anvil by a width ranging between 0.015 inches and 0.060 inches, and wherein the rotary knife is driven at a speed between about 2 percent and about 5 percent greater than the microencapsulated imaging media speed.

12. The method of claim 11, wherein the rake angle is about 60 degrees.

13. The method of claim 11, wherein the rotary knife is mounted on a first shaft and the rotary anvil is mounted on a second shaft, and wherein the microencapsulated imaging media material is fed between the first shaft and the second shaft.

14. The method of claim 11, wherein the rotary knife comprises a lateral force, wherein the lateral force against the rotary anvil is between about 9 Newtons and about 23 Newtons.

15. The method of claim 11, wherein the rotary knife comprises a positive relief angle between 1 degree and 6 degrees.

16. The method of claim 11, wherein the light sensitive side is positioned during cutting such that the rotary knife contacts the emulsion side.

17. The method of claim 11, wherein a side opposite the light sensitive side is positioned during cutting such that the rotary knife contacts the side opposite the light sensitive size.

18. A system for slitting and chopping microencapsulation imaging media for photographic images to provide borderless color prints without a bleed edge, wherein the system comprises
a. a plurality of LEDs mounted on a moveable module;
b. a slitting and chopping apparatus comprising knives, wherein the slitting and chopping apparatus is adapted to receive microencapsulated imaging media with a light-sensitive side having a plurality of monomer capsules containing leuco forming dyes suspended in a matrix containing a developer; and
c. a controller adapted to control intensity of the LEDs and to move the LEDs simultaneously with the knives, for the LEDs to form first and second differently oriented polymerization patterns, and for the knives to precisely cut the microencapsulated imaging media along the first and second differently oriented polymerization patterns, to provide borderless color prints without a bleed edge.

19. The system of claim 18, wherein the plurality of LEDs comprise a red light, a green light, and a yellow light.

20. The system of claim 18, wherein the slitting and chopping apparatus includes a guillotine knife connected to a positioning controller, wherein the guillotine knife is adapted to chop the media forming a cut sheet that matches the second polymerization pattern.

21. A method of slitting and chopping microencapsulation imaging media for photographic images to provide borderless color prints without a bleed edge, wherein the method comprises the steps of:
irradiating microencapsulated imaging media including a light sensitive side having an emulsion with capsules containing leuco forming dyes suspended in a matrix containing developer;
using a first frequency of a visible energy beam to polymerize a first set of the capsules into a first polymerization pattern that matches a point of contact with the visible energy beam,
slitting precisely the microencapsulated imaging media into a plurality of smaller microencapsulated imaging media along the first polymerization pattern to form a slit web media.
stopping the slit web media;
irradiating the stopped slit web media using a second frequency of a visible energy to polymerize a second set of the capsules into a second polymerization pattern that matches a point of contact with the visible energy beam and that is oriented 180 degrees from the first polymerization pattern; and
chopping the slit web media along the second polymerization pattern to form a cut sheet of borderless color prints without a bleed edge.

22. The method of claim 21, wherein the slit web media is oriented 180 degrees from where the microencapsulated imaging media is irradiated so that the second polymerization pattern is oriented 180 degrees from the first polymerization pattern.

23. The method of claim 21, wherein the slit web media is irradiated 180 degrees from where the microencapsulated imaging media is irradiated so that the second polymerization pattern is oriented 180 degrees from the first polymerization pattern.

24. The method of claim 21, wherein the first and second polymerization patterns are patterned lines.

25. A method of slitting and chopping microencapsulation imaging media for photographic images to provide borderless color prints without a bleed edge, wherein the method comprises the steps of:
irradiating microencapsulated imaging media including a light sensitive side having an emulsion with capsules containing leuco forming dyes suspended in a matrix containing developer;
using a first frequency of a visible energy beam to polymerize a first set of the capsules into a first polymerization patterned line that matches a point of contact with the visible energy beam;
slitting precisely the microencapsulated imaging media into a plurality of smaller microencapsulated imaging media along the first polymerization pattern to form a slit web media.
stopping the slit web media;
irradiating the stopped slit web media using a second frequency of a visible energy to polymerize a second set of the capsules into a second polymerization patterned line that matches a point of contact with the visible energy beam and that is oriented differently than the first polymerization patterned line; and
chopping the slit web media along the second polymerization patterned line to form a cut sheet of borderless color prints without a bleed edge.
